(19) United States
(12) Patent Application Publication
(10) Pub. No.: US 2005/0206952 A1
(43) Pub. Date: Sep. 22, 2005

(54) Image processing device, processing system and image processing method

(75) Inventor: Yuji Hikawa, Ebina-shi (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 11/081,712

(22) Filed: Mar. 17, 2005

(30) Foreign Application Priority Data
Mar. 22, 2004 (JP) 2004-83693

(51) Int. Cl. G06F 15/00

(52) U.S. Cl. 358/1.15

(57) ABSTRACT

An image processing device for executing flow processing on the basis of linking information which represents a series of flow processing relating to document data and an external processing execution request transmission process are linked, the external processing execution request transmission process transmitting an execution request for external processing which relates to document data and is executed outside the image processing device, the device includes: a receiving section which receives at least one of image display data and an image display program, which are transmitted from an external device and reflecting a result of execution of the external processing, the external device executing the external processing in accordance with the external processing execution request; and a display section which displays an image based on the at least one of image display data and an image display program received by the receiving section.

### CROSS-REFERENCE TO RELATED APPLICATION

This application claims priority under 35 USC 119 from Japanese Patent Application No. 2004-83693, the disclosure of which is incorporated by reference herein.

### BACKGROUND OF THE INVENTION

1. Field of the Invention

The present invention relates to an image processing device, a processing system and an image processing method, and more particularly relates to an excellent image processing device, processing system and image processing method to be used in a document processing network system or the like in which paper documents, electronic information and the like are to be commonly used.

2. Description of the Related Art

It is known to provide technologies relating to distributed processing systems, in which programs and services (functions) distributed over a network are linked and series of processes are executed. When input/output functions and programs which are operated on various devices connected to a network are to be combined for linked processing in accordance with usage methods of individual users, the network linking apparatus propagates linked processing data between the various linked devices in accordance with a processing sequence.

Specifically, in an office environment or the like, there is a distributed processing-type document processing network system in which a scanner, a facsimile device, a photocopier, a multifunction device which incorporates these functions, personal computers, a mail server and suchlike are connected to one another by a network and services provided by these various devices are linked for processing document data. Such a document processing network system performs linked processing by sequentially propagating linking information, which includes linking relationships between various services, input/output information and the like, between the devices that provide the services.

However, in a conventional network linking apparatus, document processing network system or the like, it is not possible to provide high-level services in which paper documents and electronic data are merged.

### SUMMARY OF THE INVENTION

The present invention has been made in view of the above circumstances and provides an image processing device, processing system and image processing method which are capable of providing high level services, by causing processing relating to document data to be executed at an external device, receiving image display data which reflects results of the execution of this processing, and displaying the image display data.

According to an aspect of the present invention, an image processing device of the present invention is an image processing device which includes: a processor that executes flow processing on the basis of linking information which represents a series of flow processing, in which a process relating to document data and a process for requesting execution of an external processing relating to document data executed by an external device are linked; a request transmitting unit that transmits a request for executing the external processing in accordance with the linking information; a receiver that receives at least one of image display data and an image display program reflecting a result of the execution of the external processing from the external device; and a display that displays an image based on the at least one of the image display data and the image display program received by the receiver.

A processing system of the present invention is a processing system which includes: an image processing device that executes flow processing, the image processing device including a processor that executes flow processing on the basis of linking information which represents a series of flow processing, in which a process relating to document data and a process for requesting execution of an external processing relating to document data executed by an external device are linked, a request transmitting unit that transmits a request for executing the external processing in accordance with the linking information, a receiver that receives at least one of image display data and an image display program which reflect a result of the execution of the external processing from the external device, and a display that displays an image based on the at least one of the image display data and the image display program received by the receiver; and an external device that executes an external processing, the external device including an external processor that executes the external processing in accordance with the request for executing the external processing transmitted from the image processing device, and a transmitting unit that transmits at least one of the image display data and the image display program, which reflect the result of the execution of the external processing, to the image processing device.

An image processing method of the present invention is an image processing method which includes: executing flow processing on the basis of linking information which represents a series of flow processing, in which a process relating to document data and a process for requesting execution of an external processing relating to document data executed by an external device are linked; transmitting a request for executing the external processing in accordance with the linking information; receiving at least one of image display data and an image display program reflecting a result of the execution of the external processing from the external device; and displaying an image based on the at least one of the received image display data and the received image display program.

### BRIEF DESCRIPTION OF THE DRAWINGS

Embodiments of the present invention will be described in detail based on the figures, wherein:

FIG. 1 is a structural diagram of a service processing system relating to an embodiment of the present invention;

FIG. 2 is a block diagram showing structure of an image processing device;

FIG. 3 is a block diagram showing structure of an external server;

FIG. 4 is a flowchart showing a processing routine for executing services in accordance with an instruction file;

FIG. 5 is a flowchart showing a processing routine which is executed at the external server; FIG. 6 is a diagram showing an example of structure of an instruction file.

### DETAILED DESCRIPTION OF THE INVENTION

Herebelow, an embodiment of the present invention will be described in detail with reference to the drawings.

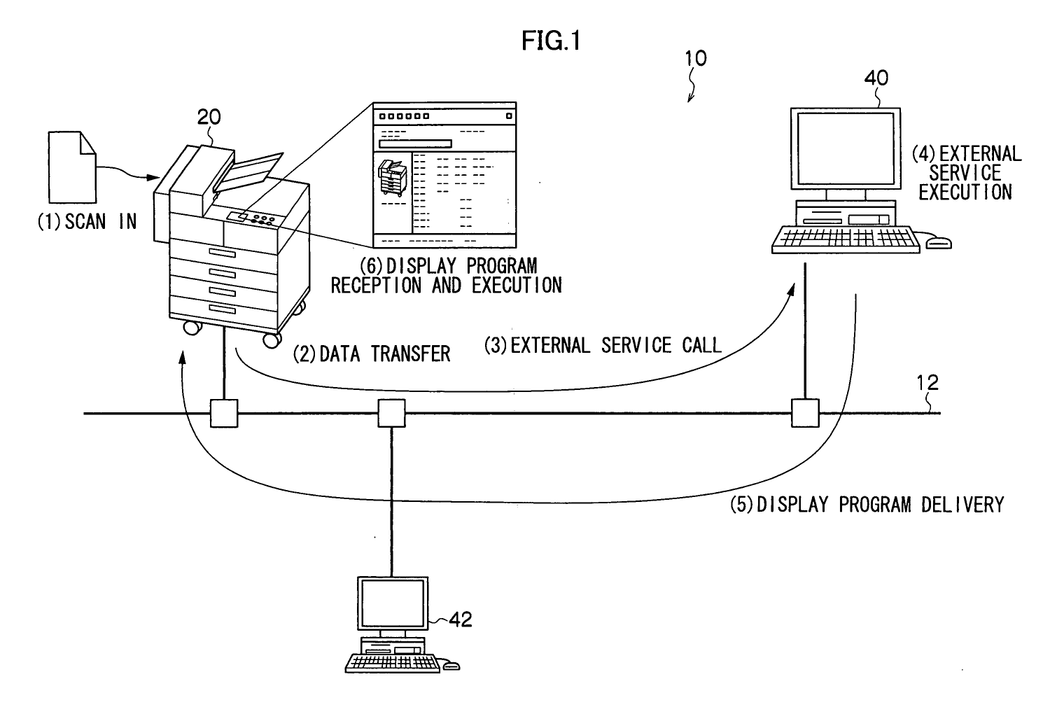

FIG. 1 is a structural diagram of a service processing system 10 relating to the present embodiment.

The service processing system 10 is connected to various services and applications via a network 12. “Services” means functions which can be utilized in relation to documents, and corresponds to, for example, copying, printing, scanning, facsimile communications, e-mail distribution, file transfers, noise reduction processing and so forth.

The service processing system 10 is structured to include an image processing device 20, an external server 40, and a document storage server 42. The image processing device 20is a multifunction device which is equipped with a combination of printing functions, scanning functions and facsimile functions. The image processing device 20 provides one or plural services in accordance with an instruction file. The external server 40 executes external services in accordance with external service execution requests transmitted from the image processing device 20. The document storage server 42 stores data relating to documents.

Herein, an “instruction file” means data which represents a sequence of flow processing in which processing of services which can be executed by the image processing device 20 and processing of external service calls, which transmit external service execution requests, are linked. The external services are services which are executed externally to the image processing device 20, and may be, for example, services which cannot be provided by the image processing device 20. “Linking” means information including relationships between services, which determines a service to be launched subsequent to results of another service, effects to be applied to operations of subsequent services, and the like. Because external service execution request transmission processes are included in the flow processing of the instruction file, it is possible to link various services of the image processing device 20 with external services for processing thereof.

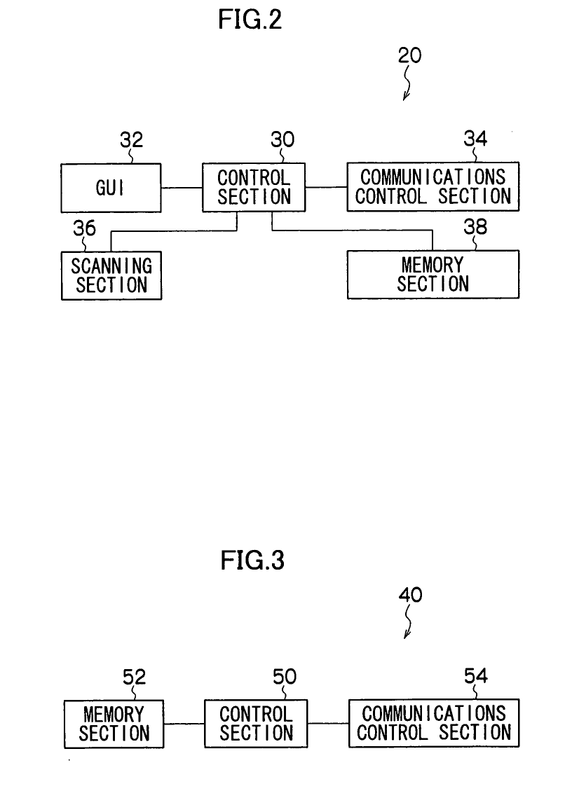

FIG. 2 is a block diagram showing structure of the image processing device 20. The image processing device 20 is provided with a control section 30, and the control section 30 is connected with a graphic user interface (GUI) 32, a communications control section 34, a scanning section 36 and a memory section (storing section) 38.

The control section 30 is structured by a microcomputer which includes a CPU and ROM. The control section 30 controls overall operations of the image processing device 20. A program of a processing routine for executing services in accordance with an instruction file is memorized in the unillustrated ROM of the control section 30.

The GUI 32 is structured by, for example, a touch-panel display or the like. The GUI 32 displays images in accordance with image display data which is received from the external server 40 and the like. A user uses the GUI 32 to perform predetermined controls. The communications control section 34 is connected to the network 12, and implements transmission and reception of various kinds of data to and from the external server 40, the document storage server 42 and the like. The scanning section 36 acquires images recorded on recording media, such as paper and the like, in accordance with control by the control section 30. Instruction files and suchlike which are received by the communications control section 34 are stored to the memory section 38. Note that structural elements which implement printing functions and facsimile functions are not shown in the drawing.

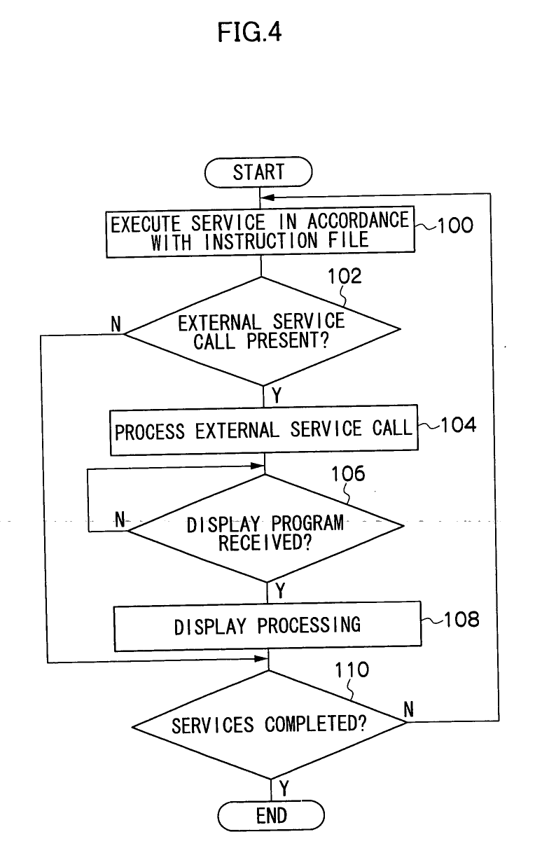

FIG. 3 is a block diagram showing structure of the external server 40. The external server 40 is equipped with a control section 50, a memory section 52 and a communications control section 54.

The control section 50 is structured by a microcomputer including a CPU and ROM, and controls each of structural sections of the external server 40. The communications control section 54 is connected to the network 12, and implements transmission and reception of various kinds of data to and from the image processing device 20, the document storage server 42 and the like. Various kinds of data received by the communications control section 54 are memorized in the memory section 52. An assortment of various image display programs for displaying images, which reflect results of executions of external services, at the GUI 32 of the image processing device 20 are memorized in advance in the memory section 52.

The document storage server 42 has a similar structure to the external server 40, and can store data which has been transferred from the image processing device 20, the external server 40 and the like in a memory section.

Herebelow, processing that is executed by the service processing system 10 will be described.

First, an instruction file which has been created by an unillustrated instruction file creation device, which is connected to the network 12, is transmitted to the image processing device 20. The image processing device 20 receives the transmitted instruction file and stores the instruction file at the memory section 38. At a time/date specified in the stored instruction file, or when an event which is a trigger for commencing execution of the instruction file occurs, the image processing device 20 starts a processing routine for executing services in accordance with the instruction file.

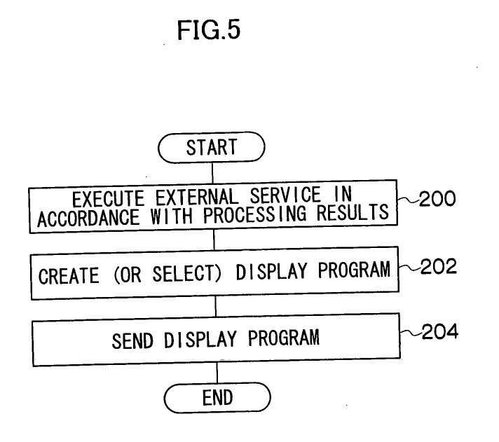

FIG. 4 is a flowchart showing the processing routine for executing services in accordance with the instruction file. Here, as an example, a case of executing services in accordance with the example instruction file given in FIG. 6 will be described.

The instruction file exemplified in FIG. 6 is written in XML (eXtensible Markup Language) format. This instruction file represents a series of flow processing in which processing of plural services and processing of an external service call are linked. Details of processing for each of the services are shown in a portion enclosed between a beginning tag <xxxxx> and a closing tag</xxxxx>. In FIG. 6, portion 60, which is enclosed between <scan> and </scan>, represents details of processing of a scanning service, portion 62, which is enclosed between <file transfer> and </file transfer>, represents details of processing of a file transfer service, and portion 66, which is enclosed between <display> and </display>, represents details of processing of a display service. Further, portion 64, which is shown as <external service call url=“xxxx.xxx”/>, represents processing of an external service call. The portion shown as url=“xxxx.xxx” in this tag represents a URL to which an external service execution request is to be transmitted. In the present embodiment, the external server 40 corresponds to the URL.

When an unillustrated start button provided at the image processing device 20 is pressed by a user, this processing routine is launched. In step 100, a service is executed in accordance with the instruction file. In the present case, as shown in FIG. 6, processing of the scanning service portion 60 of the instruction file is executed first, and an image of a predetermined original is scanned by the scanning section 36 ((1) in FIG. 1). Then, a document number is assigned to image data of the scanned image by the file transfer service 62, and the image data is transferred by FTP to the document storage server 42 and stored ((2) of FIG. 1). The document number of the image data and the storage location (i.e., location information) are stored at the memory section 38.

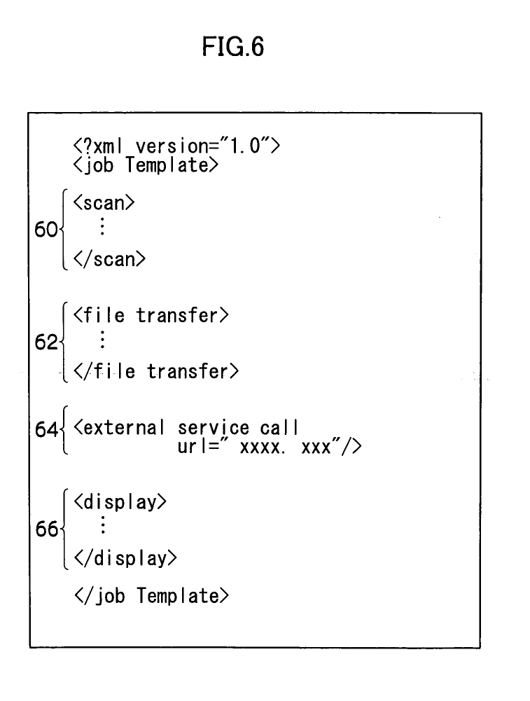

A next step 102 determines whether or not processing of an external service call is included in the series of flow processing. In the instruction file exemplified in FIG. 6, because the portion 64 which represents processing of an external service call is included, the determination is positive in this case. Subsequently, in step 104, processing of the external service call is executed in accordance with the instruction file. In the present case, the document number of the image data obtained by scanning the image with the scanning service, the location information of this image data and the like are included in the external service execution request that is transmitted, to serve as information representing results of previous processing ((3) in FIG. 1). For example, a log, which includes the document number and location information of the image data, system data and the like are converted to XML, included in a SOAP (Simple Object Access Protocol) message which serves as the external service execution request, and transmitted to the external server 40. FIG. 5 is a flowchart showing a processing routine which is executed at the external server 40. This processing routine starts when triggered by reception of the external service execution request.

In step 200, an external service is executed on the basis of the information which represents processing results. In the present case, the document storage server 42 is accessed on the basis of the information of processing results which have been converted to XML and included in the SOAP message, the image data of the image is acquired, and a predetermined service (the external service) is executed in relation to the acquired image data ((4) in FIG. 1).

In step 202, an image display program which reflects results of execution of the external service is selected from the plurality of image display programs stored in the memory section 52. In step 204, the selected image display program is sent to the image processing device 20 ((5) in FIG. 1).

After the external service execution request has been transmitted in the above-described step 104, the image processing device 20 waits until an image display program is received from the external server 40. When, in step 106, it has been determined that the image display program has been received, in step 108, processing of the display service portion 66 of the instruction file is executed, the image display program is executed, and an image reflecting the results of execution of the external service is displayed at the GUI 32 ((6) in FIG. 1). After display of this image, the routine advances to step 110.

In a case in which no external service call process is included in the instruction file and the determination of step 102 is negative, the routine advances to step 110 without performing the processing of steps 104 to 108.

Step 110 determines whether or not execution of the services of the instruction file (the series of flow processing) has completely finished. Here, if it is determined that the series has not finished, the routine returns to step 100 and the services are continued in accordance with the instruction file. When it is determined that execution of the services has completely finished, the processing routine finishes.

As has been described above, processing relating to an image acquired at the image processing device 20 is executed at the external server 40 as an external service, and an image display program reflecting a result of this execution is received and is displayed in the GUI 32. Thus, it is possible to provide high-level services in which paper documents and electronic data are merged.

Note that the present invention is not limited to the embodiment described above, and various modifications can be applied within the scope of the invention as recited in the claims.

For example, for the embodiment described above, an example has been described which executes various services, including external services, in relation to image data obtained by scanning an image with the scanning section 36. However, the present invention is not limited thus. For example, the various services may be executed in relation to document data that has been memorized at the image processing device 20, document data that has been inputted at the image processing device 20, and the like.

Further, for the embodiment described above, an example has been described which FTP-transfers image data obtained by scanning an image with the scanning section 36 to the document storage server 42, and which includes location information of the image data when transmitting an external service execution request. However, the image data obtained by scanning could be transferred directly to the external server 40.

Further again, for the embodiment described above, an example has been described in which the image display program reflecting the results of execution of an external service is selected from the memory section 52 and transmitted. However, each time an external service is executed, a new image display program could be created in accordance with the results of execution and transmitted.

Further still, for the embodiment described above, an example has been described in which the image display program reflecting the results of execution is sent to the image processing device 20. However, this is not limited to programs. For example, data that reflects the results of execution could be used.

Further yet, for the embodiment described above, an example has been described which executes the received image display program to display an image in accordance with the instruction file. However, an image could, for example, always be displayed in accordance with an image display program, image display data or the like when the program, data or the like is received, regardless of the instruction file.

Further still again, for the embodiment described above, an example has been described in which the image display program is directly transmitted from the external server 40 to the image processing device 20. However, the present invention is not limited thus. For example, the image display program may be transferred to and stored at the document storage server 42, and information representing the storage location thereof sent to the image processing device 20. For example, in a case of displaying an image at the GUI 32 with a web browser, if an image display program (an HTML file) is stored at the document storage server 42 and just a URL representing the storage location is transmitted to the image processing device 20, the web browser can easily acquire the HTML file and display the image reflecting the results of processing.

Now, an example of application of the service processing system 10 described in the above embodiment to a concert ticket reservation system will be described. This concert ticket reservation system may have a structure in which the image processing device 20 is disposed in a convenience store or the like for performing ticket booking processing, and the external server 40, which serves as a ticket reservation center for carrying out ticket reservation processing (an external service), is connected through the network 12 to the image processing device 20.

First, when a menu item which instructs initiation of a concert ticket reservation service is selected from menu items displayed at the GUI 32 of the image processing device 20, execution of an instruction file for concert ticket reservation is commenced. A user fills out required details on a ticket booking form with a pencil or the like, and then the user sets this form on a platen glass of the image processing device 20 and presses a start button of the scanning section 36. The image processing device 20 scans an image of the paper that has been set on the platen (step 100 of FIG. 4), transfers the image to the external server 40, and sends an external service execution request to the external server 40 (steps 102 and 104 of FIG. 4).

The external server 40 that has received this request executes the ticket reservation processing (the external service) in accordance with contents of the data of the booking form that has been transferred from the image processing device 20 (step 200 of FIG. 5). Then, the external server 40 generates (or selects) an image display program in accordance with a result of the reservation processing (e.g., accepted/refused) and sends the image display program to the image processing device 20 (steps 202 and 204 of FIG. 5).

When the image processing device 20 receives the image display program that has been sent from the external server 40 (step 106 of FIG. 4), the image processing device 20 executes the image display program and displays an image of the result of reservation processing in the GUI 32 (step 108 of FIG. 4).

Here, rather than just a reservation status such as accepted/refused or the like, information relating to the concert, such as, for example, information about the concert, advertisements showing brand marks of sponsors of the concert and the like, may be displayed to the user in the image of reservation processing results that is displayed at the GUI 32.

Further yet, the service processing system 10 described above may be applied to, for example, a fortune-telling system. To be specific, a structure is possible in which the image processing device 20, which scans palm-prints, is provided in a convenience store, a video arcade or the like, and the external server 40, which performs processing for analyzing the palm-prints (an external service), is connected via the network 12. An instruction file of the fortune-telling service is initiated in a similar manner to the concert reservation system described above. A palm-print of a user is scanned by the image processing device 20, and image data which is obtained thus is sent to the external server 40 together with an external service execution request. Accordingly, the external server 40 executes fortune-telling processing in accordance with the received image data of the palm-print, creates an image display program for showing execution results thereof (fortune-telling results), and sends the image display program to the image processing device 20. Hence, the fortune-telling results are displayed by the GUI 32 of the image processing device 20.

Further yet again, the service processing system 10 described above may be applied to a maintenance system. During maintenance of the image processing device 20, a customer service engineer initiates an instruction file for maintenance at the image processing device 20. The customer service engineer scans test print results, a test chart and the like with the scanning section 36 of the image processing device 20, and sends results to the external server 40. The external server 40 (a maintenance server) that has received the acquired results creates (or selects) an image display program in response to the acquired results and sends the image display program to the image processing device 20. The image display program may be a program which shows, for example, a setting/adjustment process, a component replacement process or the like. Thus, by simply executing this image display program, the image processing device 20 is capable of real-time, on-demand display of an appropriate setting process to the customer service engineer.

As described above, some embodiments of the invention are outlined below.

In the embodiment of this invention, an image processing device executes a flow process in accordance with linking information which represents a sequence of flow processing, in which processes relating to document data and processes for requesting execution of an external processing are linked. A requesting processing transmits a request for executing the external processing, which are executed on document data at external sections, in accordance with the linking information.

Herein, the document data may be information relating to a document, such as character information such as text data or the like, image information acquired from paper documents and so forth, and is not particularly limited. Furthermore, the processes which are executed on the document data are not particularly limited, and can be, for example, input/output of images relating to the document data, image processing and so forth.

Further, external processing means processes which are carried out in relation to document data outside of the image processing device, and may be, for example, processes which are difficult to execute at the image processing device. The external processing execution request transmission processes included in the linking information are processes which send execution requests for external processing to external devices. Thus, it is possible to link and process processes which are executed in the image processing device and external processes which are executed at external sections.

The external device executes external processing in accordance with an execution request for external processing that has been sent from the image processing device on the basis of the linking information, and sends image display data or the like which reflects a result of the execution of the external processing to the image processing device. When the receiving section of the image processing device receives this image display data, the display section of the image processing device displays an image based on the image display data.

Here, the image display data is not particularly limited as long as it reflects a result of execution of the external processing. For example, the image display data may be plain data and may be a program for displaying an image. Further, the receiving section may be structured so as to directly receive the image display data from the external device, and may receive the image display data indirectly. For example, in a case in which the image is displayed at the display section by a web browser, if the receiving section only receives a URL (Uniform Resource Locator) representing a location of hypertext (the image display data) which is written in HTML to reflect the results of execution of the external processing, the receiving section may, in accordance with this URL, receive the hypertext by file transfer using the HTTP protocol and display the image with the web browser. Therefore, it is possible to display an image at the display section without directly receiving the image display data.

Thus, it may be possible to provide high-level services, by executing processes relating to document data at external devices and receiving and displaying image display data which reflects results of these executions.

Further, the image processing device of the present invention may further includes an acquisition section which acquires an image, the receiving section receiving at least one of image display data and an image display program, the at least one of image display data and an image display program being transmitted from the external device and reflecting a result of execution of the external processing, the external device executing the external processing in relation to the acquired image in accordance with the external processing execution request, and the image being acquired by the acquisition section in accordance with the linking information.

1. An image processing device comprising:
a processor that executes flow processing on the basis of linking information which represents a series of flow processing, in which a process relating to document data and a process for requesting execution of an external processing relating to document data executed by an external device are linked;
a request transmitting unit that transmits a request for executing the external processing in accordance with the linking information;
a receiver that receives at least one of image display data and an image display program reflecting a result of the execution of the external processing from the external device; and
a display that displays an image based on the at least one of the image display data and the image display program received by the receiver.

2. The image processing device of claim 1, further comprising an acquisition unit that acquires an image data by reading the document data, wherein
the processor executes a processing of acquiring the image data with the acquisition unit, and
the request transmitting unit transmits the request for executing the external processing on the image data to the external device.

3. A processing system comprising:
an image processing device that executes flow processing, the image processing device including a processor that executes flow processing on the basis of linking information which represents a series of flow processing, in which a process relating to document data and a process for requesting execution of an external processing relating to document data executed by an external device are linked, a request transmitting unit that transmits a request for executing the external processing in accordance with the linking information, a receiver that receives at least one of image display data and an image display program which reflect a result of the execution of the external processing from the external device, and a display that displays an image based on the at least one of the image display data and the image display program received by the receiver; and
an external device that executes an external processing, the external device including an external processor that executes the external processing in accordance with the request for executing the external processing transmitted from the image processing device, and a transmitting unit that transmits at least one of the image display data and the image display program, which reflect the result of the execution of the external processing, to the image processing device.

4. The processing system of claim 3, the image processing device further comprising an acquisition unit that acquires an image data by reading the document data, wherein
the processor executes a processing of acquiring the image data with the acquisition unit,
the request transmitting unit transmits the request for executing the external processing on the image data to the external device, and
the external processor executes the external processing on the image acquired by the acquisition unit in accordance with the request for executing the external processing transmitted from the image processing device.

5. A processing system comprising:
an image processing device which provides one or plural services in accordance with an instruction file;
an external server which executes an external service in accordance with an execution request for the external service, the external service execution request being transmitted from the image processing device and the external service being executed outside of the image processing device; and
a document storage server which stores data relating to a document.

6. The processing system of claim 5, wherein the instruction file comprises data representing a series of flow processing, in which series processing of at least one service that is executable at the image processing device and processing for requesting execution of the external service are linked.

7. The processing system of claim 5, wherein the image processing device comprises:
a controller;
a graphical user interface connected with the controller;
a communications controller connected with the controller;
a scanner connected with the controller; and
a memory connected with the controller.

8. The processing system of claim 7, wherein the controller is structured by a microcomputer including a CPU and ROM, and controls overall operations of the image processing device.

9. The processing system of claim 8, wherein a program of a processing routine for executing a service in accordance with the instruction file is memorized at a ROM of the controller.

10. The processing system of claim 7, wherein the graphical user interface is structured by a touch-panel display, and the graphical user interface displays an image based on image display data received from the external server and implements predetermined control by a user.

11. The processing system of claim 7, wherein the communications controller is connected to a network, and implements transmission and reception of data to and from at least the external server and the document storage server.

12. The processing system of claim 7, wherein the scanner acquires an image recorded at a recording medium in accordance with control by the controller.

13. The processing system of claim 7, wherein the memory memorizes an instruction file received by the communications controller.

14. The processing system of claim 5, wherein the external server comprises:
an external server controller;
an external server memory; and
an external server communications controller.

15. The processing system of claim 14, wherein the external server controller is structured by a microcomputer including a CPU and ROM, and controls structural sections of the external server.

16. The processing system of claim 14, wherein the external server communications controller is connected to a network, and implements transmission and reception of data to and from at least the image processing device and the document storage server.

17. The processing system of claim 14, wherein the external server memory memorizes data received by the external server communications controller and memorizes, in advance, an image display program for displaying an image that reflects a result of execution of the external service at a graphical user interface of the image processing device.

18. The processing system of claim 6, wherein the document storage server comprises a memory which records data transferred from the image processing device and the external server.

19. An image processing method comprising:
executing flow processing on the basis of linking information which represents a series of flow processing, in which a process relating to document data and a process for requesting execution of an external processing relating to document data executed by an external device are linked;
transmitting a request for executing the external processing in accordance with the linking information;
receiving at least one of image display data and an image display program reflecting a result of the execution of the external processing from the external device; and
displaying an image based on the at least one of the received image display data and the received image display program.
